(19) United States
(12) Patent Application Publication
(10) Pub. No.: US 2011/0268001 A1
(43) Pub. Date: Nov. 3, 2011

(54) METHOD OF PROVIDING ACKNOWLEDGEMENT FEEDBACK FOR AGGREGATED CARRIERS

(76) Inventors: Jung A. Lee, Pittstown, NJ (US); Matthew P.J. Baker, (US); Fang-Chen Cheng, Murray Hill, NJ (US)

(21) Appl. No.: 13/042,788

(22) Filed: Mar. 8, 2011

Related U.S. Application Data
(60) Provisional application No. 61/330,670, filed on May 3, 2010.

(51) Int. Cl. H04W 72/04; H04W 52/02

(52) U.S. Cl. 370/311; 370/329

(57) ABSTRACT

The present invention provides a method and apparatus for providing acknowledgment feedback for aggregated downlink component carriers. One embodiment of the method includes determining acknowledgment bits for downlink component carriers that are aggregated to a particular user equipment. Each acknowledgment bit indicates whether a corresponding downlink component carrier was successfully received. This embodiment also includes transmitting symbol constellations representative of the acknowledgment bits in resources of one or more uplink control channels of the uplink component carrier.

### CROSS REFERENCE TO RELATED APPLICATIONS

This application claims priority to U.S. Provisional Patent Application 61/330,670 filed on May 4, 2010.

### BACKGROUND OF THE INVENTION

1. Field of the Invention

This invention relates generally to communication systems, and, more particularly, to wireless communication systems.

2. Description of the Related Art

Wireless communication systems provide wireless connectivity to access terminals using a network of interconnected access nodes or base stations. Communication over the air interface between the access terminals and the base stations take place according to various agreed-upon standards and/or protocols. For example, the Third Generation Partnership Project (3GPP, 3GPP2) has specified a set of standards for a packet-switched wireless communication system referred to as Long Term Evolution (LTE). The LTE standards support access schemes including single-carrier frequency division multiple access (SC-FDMA). Multiple users can concurrently access the SC-FDMA network using different sets of non-overlapping Fourier-coefficients or sub-carriers. One distinguishing feature of SC-FDMA is that it leads to a single-component carrier transmit signal. The LTE standards also support multiple-input/multiple-output (MIMO) communication over the air interface using multiple antennas deployed at transmitters and/or receivers. The carrier bandwidth supported by LTE is approximately 20 MHz, which can support a downlink peak data rate of approximately 100 Mbps and a peak data rate of the uplink of approximately 50 Mbps.

One of the primary goals of subsequent standards such as LTE-Advanced (LTE-A) is to achieve significantly higher bandwidths. LTE-A therefore implements carrier aggregation to extend the available bandwidth beyond the limits of LTE. For example, a system that operates according to LTE-A supports multiple component carriers that are analogous to the single component carrier used in a SC-FDMA system that operates according to LTE. The multiple component carriers can be allocated independently or they can be aggregated so that a single transmitter can combine the resources of multiple component carriers for concurrent transmission to a single receiver. Each component carrier in LTE-A has a bandwidth of approximately 20 MHz (for backwards compatibility to LTE) and LTE-A supports five component carriers. The maximum aggregated carrier bandwidth supported by LTE-A is therefore approximately 100 MHz, which can support a downlink peak data rate of approximately 1 Gbps and a peak data rate on the uplink of approximately 100 Mbps.

The LTE and LTE-A standards also support acknowledgment feedback such as hybrid automatic repeat request (HARQ) feedback over the uplink channel. Consequently, the LTE-A standards must provide a HARQ feedback procedure that supports carrier aggregation and spatial diversity using downlink MIMO techniques. Aggregated channels require additional feedback bits to convey the acknowledgment information for each of the component carriers. One proposal is therefore to modify the format of the physical uplink control channel (PUCCH) to increase the size of the ACK/NAK codebook. However, implementing this proposal requires significant modifications to the specification of the LTE-A standard and would require implementing new transceivers in both the access terminals and the base stations to support the new channel format.

### SUMMARY OF EMBODIMENTS OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for providing acknowledgment feedback for aggregated downlink component carriers. One embodiment of the method includes determining acknowledgment bits for downlink component carriers that are aggregated to a particular user equipment. Each acknowledgment bit indicates whether a corresponding downlink component carrier was successfully received. This embodiment also includes transmitting symbol constellations representative of the acknowledgment bits in resources of one or more uplink control channels of the uplink component carrier.

In another embodiment, a method is provided for receiving acknowledgment feedback for aggregated downlink component carriers. One embodiment of the method includes transmitting downlink component carriers that are aggregated to a particular user equipment. This embodiment also includes receiving symbol constellations representative of acknowledgment bits for the plurality of downlink component carriers. The symbol constellations are received in resources of one or more uplink control channels of an uplink component carrier. Each acknowledgment bit indicates whether a corresponding downlink component carrier was successfully received.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates one exemplary embodiment of a wireless communication system;

FIG. 2 conceptually illustrates a plurality of component carriers may be used for uplink and/or downlink communication;

FIG. 3 conceptually illustrates one exemplary embodiment of a legacy component carrier;

FIG. 4 conceptually illustrates one exemplary embodiment of a resource allocation for providing acknowledgment feedback over multiple uplink control channels; and

FIG. 5 conceptually illustrates one exemplary embodiment of spatial bundling of codewords transmitted on component carriers.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, the present application describes techniques for providing acknowledgment feedback for aggregated downlink component carriers. Embodiments of systems that implement carrier aggregation typically require uplink acknowledgment feedback for each of the aggregated downlink component carriers. However, in some embodiments the conventional one-to-one mapping between uplink and downlink channels is replaced by a one-to-many mapping between the uplink and downlink channels. For example, the air interface between a base station and user equipment may only support a single uplink carrier, perhaps due to physical limitations such as the number of antennas and/or transmission power available at the user equipment. For another example, wireless communication standards such as those established by the 3GPP may dictate that only a single uplink carrier can include a physical uplink control channel even though multiple uplink carriers may be available for data transmission. This problem may be exacerbated by standards that support transmitting multiple code words on each downlink component carrier because one acknowledgment bit may be transmitted for each codeword.

At least in part to address these drawbacks in the conventional practice, acknowledgment feedback such as acknowledgment bits may be generated using a component-carrier-to-acknowledgment mapping instead of a conventional subframe-to-acknowledgment mapping. In one embodiment, user equipment attempt to demodulate and/or decode the received downlink component carriers. Based on the success or failure of these attempts, the user equipment determines the appropriate acknowledgment bits and may then map the determined acknowledgment bits to symbol constellations for transmission in resources of one or more uplink control channels of a single uplink component carrier. The acknowledgment bits indicate whether codewords transmitted over aggregated downlink component carriers were successfully received at the user equipment. User equipment can transmit signal constellations representative of the acknowledgment bits in the resources of the uplink control channel. The base station can then use the received acknowledgment bits to determine whether transmission of the downlink control channels was successful and/or whether any of the downlink control channels should be retransmitted. In one embodiment, four resource blocks of one physical uplink channel may be allocated to transmit QPSK symbols so that four acknowledgment bits are transmitted. This embodiment could be used to provide acknowledgment feedback for an aggregation of four component carriers that each transmit one codeword. In alternative embodiments, up to eight acknowledgment bits (e.g., as may be required for four downlink channels that transmit two codewords each) can be transmitted over one uplink component carrier by using two adjacent physical uplink channel resource pairs. Spatial bundling of some or all of these channels can further extend the number of supported downlink component carriers/codewords to 9/10 (or more) to cover the 5 potential component carriers that can be aggregated in LTE-A.

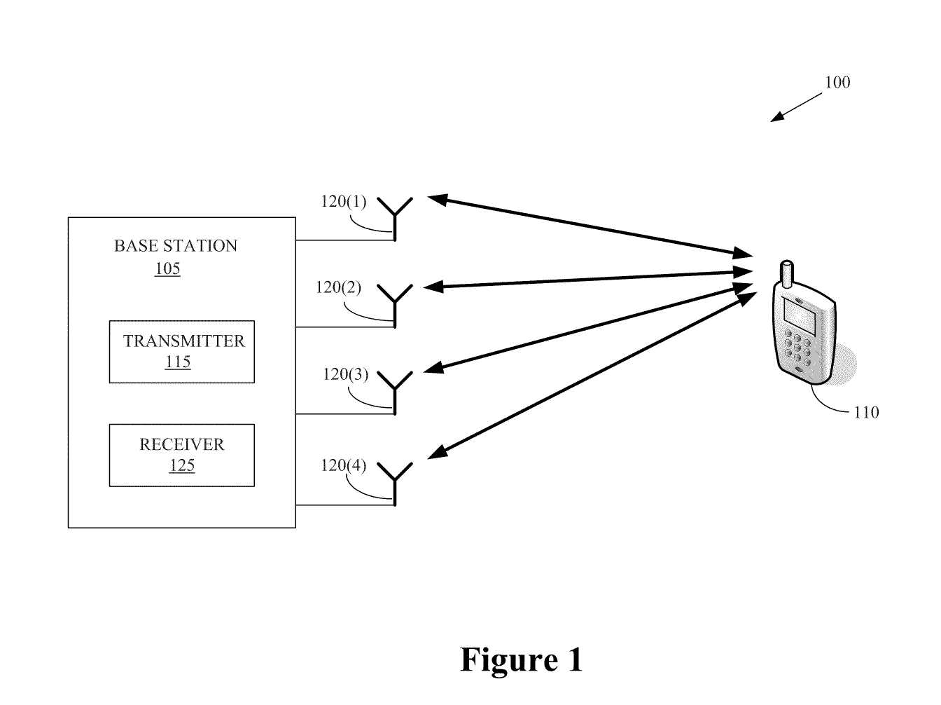

FIG. 1 conceptually illustrates one exemplary embodiment of a wireless communication system 100. In the illustrated embodiment, the wireless communication system 100 includes one or more base stations 105 that are configured to provide wireless connectivity to one or more wireless communication devices such as a mobile unit 110. Persons of ordinary skill in the art having benefit of the present disclosure should appreciate that the wireless communication system 100 may include any number of wireless access nodes including the base station 105 and/or other devices such as access points, base station routers, home base stations/router, and the like. The wireless communication system 100 may also provide wireless connectivity to any number of wireless communication devices including the mobile unit 110 and/or other mobile devices, smart phones, laptops, desktops, and the like. The base station 105 includes a transmitter 115 that can be used to modulate and encode signals for transmission over the air interface using one or more antennas 120. The base station 105 also includes a receiver 125 that can be used to demodulate and/or decode signals received over the air interface via the antennas 120.

The base station 105 and the mobile unit 110 are configured to communicate using multiple downlink and/or uplink component carriers. In the illustrated embodiment, the four antennas 120 are used to support four separate downlink component carriers that operate in different frequency ranges. A single uplink component carrier is supported between the base station 105 and the mobile unit 110. However, persons of ordinary skill in the art having benefit of the present disclosure should appreciate that alternative embodiments of the wireless communication system 100 may support different numbers of uplink and/or downlink component carriers. For example, LTE-A standards specify support for as many as five uplink and/or downlink component carriers and other standards, protocols, and/or revisions of existing standards or protocols may support different numbers of uplink and/or downlink component carriers. The base station 105 and the mobile unit 110 also support carrier aggregation, which allows multiple component carriers to be used concurrently for communication between the base station 105 and the mobile unit 110. The multiple component carriers may therefore function as a single carrier having a bandwidth that is extended in proportion to the number of aggregated carriers.

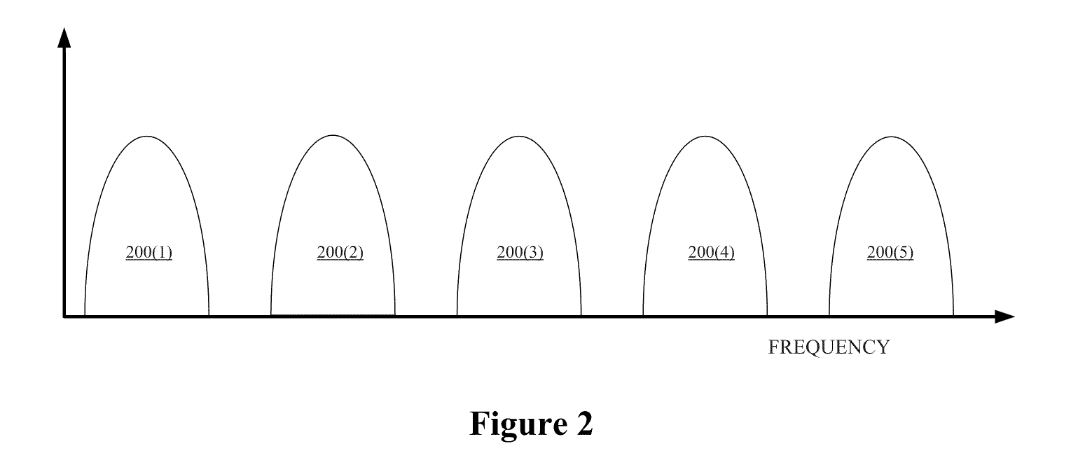

FIG. 2 conceptually illustrates a plurality of component carriers that may be used for uplink and/or downlink communication. In the illustrated embodiment, five component carriers 200 are distributed across the bandwidth or spectrum allocated for wireless communication. The component carriers 200 shown in FIG. 2 are non-contiguous, e.g., there are gaps between the bandwidth allocated to the different component carriers 200. However, in alternative embodiments the component carriers 200 may be contiguous and/or partially overlapping. In one embodiment, the carriers 200 can be aggregated. For example, a base station may communicate with a mobile node that supports carrier aggregation by aggregating carriers 200(1-3). The bandwidth of the aggregated carriers 200(1-3) is approximately 3 times the bandwidth of an individual carrier 200 and so the base station and the mobile node may be able to communicate over a bandwidth that is three times larger than the bandwidth available for communication over a single carrier 200. Aggregating multiple carriers 200 may therefore permit a higher peak data rate, while retaining flexibility to dynamically allocate different bandwidths to different mobile nodes. Backwards compatibility with legacy devices that do not support carrier aggregation may be preserved by configuring each component carrier using the same structure as the legacy component carrier.

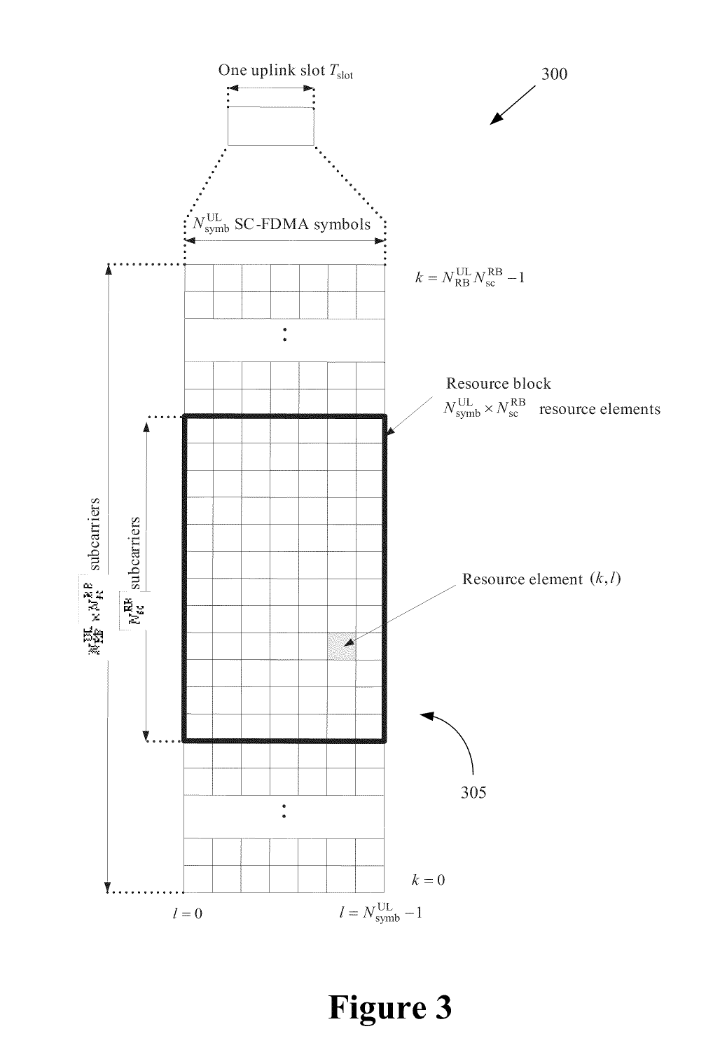

FIG. 3 conceptually illustrates one exemplary embodiment of a legacy component carrier 300. In the illustrated embodiment, the component carrier 300 is an uplink component carrier that is used for single carrier frequency division multiple access (SC-FDMA) communication over an air interface. Embodiments of structures such as the structure of the component carrier 300 depicted in FIG. 3 may also be used for other component carriers such as the multiple component carriers supported by LTE-A compliant systems. In one embodiment, the component carrier 300 is temporally divided into frames that are further temporally subdivided into subframes. Each subframe includes two timeslots. FIG. 3 depicts one exemplary uplink time slot, Tₛₗₒₜ. The transmitted signal in each slot is described by one or several resource grids 305 of N_{RB}^{UL}N_{sc}^{RB} subcarriers and N_{symb}^{UL} SC-FDMA symbols. The quantity N_{RB}^{UL} depends on the uplink transmission bandwidth configured in the cell and in embodiments that conform to the 3GPP standards, the quantity fulfils the condition:

N_{RB}^{min,UL}≦N_{RB}^{UL}≦N_{RB}^{max,UL}

where N_{RB}^{min,UL}=6 and N_{RB}^{max,UL}=110 are the smallest and largest uplink bandwidths, respectively, supported by the current version of the specification. The number of SC-FDMA symbols in a slot may depend on the cyclic prefix length configured by a higher layer parameter UL-CyclicPrefixLength.

Each element in the resource grid 305 may be referred to as a resource element and can be uniquely defined by the index pair (k,l) in a slot where k=0, . . . , N_{RB}^{UL}N_{sc}^{RB}−1 and l=0, . . . , N_{symb}^{UL}−1 are the indices in the frequency and time domains, respectively. Resource element (k,l) on antenna port p corresponds to the complex value a_{k,l}^{(p)}. When there is no risk for confusion, or no particular antenna port is specified, the index p may be dropped. Quantities a_{k,l}^{(p)} corresponding to resource elements not used for transmission of a physical channel or a physical signal in a slot may be set to zero. A physical resource block may be defined as N_{symb}^{UL} consecutive SC-FDMA symbols in the time domain and N_{sc}^{RB} subcarriers in the frequency domain. Exemplary values of N_{symb}^{UL} and N_{sc}^{RB} given by Table 1. In the illustrated embodiment, a physical resource block in the uplink consists of N_{symb}^{UL}×N_{sc}^{RB} resource elements, corresponding to one slot in the time domain and 180 kHz in the frequency domain.

TABLE 1
Exemplary resource block parameters.

| Configuration | N_{sc}^{RB} | N_{symb}^{UL} |
|---|---|---|
| Normal cyclic prefix | 12 | 7 |
| Extended cyclic prefix | 12 | 6 |

The relation between the physical resource block number n_{PRB} in the frequency domain and resource elements (k,l) in a slot may be given by the formula:

$${n}_{PRB} = ⌊ \frac{k}{{N}_{sc}^{RB}} ⌋$$

Referring back to FIG. 1, the wireless communication system 100 supports acknowledgment feedback for each of the downlink component carriers. The mobile unit 110 may therefore provide multiple HARQ ACK/NACK feedback signaling on the uplink when multiple downlink component carriers are aggregated to the mobile unit 110 for wireless communication. For example, in systems that are compliant with LTE-A, multiple HARQ feedback signaling may be used to support carrier aggregation of up to 5 carriers. The system 100 may further support single user multiple-input-multiple-output (SU-MIMO) so that two codewords can be transmitted in each subframe on each of the carriers. With n activated DL component carriers and each component carrier configured with dual codeword transmission the total number of HARQ feedback states is 5 per DL component carrier (ACK,ACK), (ACK,NACK), (NACK,ACK), (NACK,NACK) and (DTX) and 5ⁿ for the activated DL component carriers. However, in the event of not receiving any DL assignment, the mobile unit 110 may use DTX signaling to indicate failure to receive the DL assignment to the base station 105, resulting in 5ⁿ−1 states to encode. Alternatively, when a single codeword is transmitted, there may be 3ⁿ−1 states to encode. If some DL component carriers are scheduled with single codeword and some with dual codeword transmission the number of feedback states becomes IIₗ₌₁ⁿfₙ−1, with fₙ being the number of ACK/NACK feedbacks per DL component carriers (3 and 5 for single and dual codeword transmission, respectively).

A relatively large number of bits may be needed to transmit the acknowledgment feedback over the uplink channel. For 5 activated DL component carriers and each when each component carrier is scheduled with dual codeword transmission, the number of bits required to feedback the state information becomes 12 bits (assuming FDD). One proposal is to modify the control channel format so that the required codebook is adapted based on the number of activated DL component carriers. However, this proposal has significant drawbacks. Among those drawbacks are the specification effort and the need for new transceivers both for terminal transmitter and the base station receiver.

For separate mapping of ACK/NACK bits among activated carriers, only ACK and NAK bits may be encoded. However, discontinuous transmission (DTX) may arise due to missed PDCCH detection, e.g., when the mobile unit 110 does not detect or decode a DL assignment on the physical downlink control channel (PDCCH). The DTX state is not known at the mobile node 110. As such, DTX handling may be implemented at the base station receiver 125. One example of separate mapping is to reserve PUCCH (Format 1b) resources per configured carrier. With this approach, independent detection of acknowledgment channels per carrier with DTX detection may be implemented at the base station 105 (as specified in Release-8). The total number of HARQ feedback states per carrier to be encoded may therefore be reduced to 4, resulting in 4ⁿ states for n activated DL component carriers.

One problem with DTX signaling is that mobile node 110 may not be able to distinguish between a failed PDCCH detection and no PDCCH transmission from the base station 105. This may result in excessive DTX feedback even when no scheduling grant has been transmitted by the base station 105 to the mobile unit 110. In one embodiment, a dynamic PDCCH monitoring set approach may be implemented so that component carriers with PDCCH transmissions (such as assignments) are explicitly indicated in a DCI format for DL allocation in a DL anchor carrier. In this embodiment, the mobile mode 110 would be able to identify the carriers with a valid PDCCH transmission and would not need to transmit DTX. The mobile unit would only need to transmit ACK/NACK bits for each downlink component carrier in the PDCCH monitoring set, e.g., the carriers that have been identified to the mobile unit as transmitting assignment information. The number of bits of ACK/NACK signaling can therefore be reduced if the mobile node 110 knows which downlink component carriers carry PDCCH DL assignments. The dynamic PDCCH monitoring set approach could reduce the maximum required number of states for n activated DL CCs to 4ⁿ, requiring only 10 bits. At least 2 bits of ACK/NACK signaling could be saved using embodiments of this approach. In other embodiments, larger numbers of bits could be saved because there would be no ACK/NACK transmission for component carriers outside the PDCCH monitoring set in any given subframe.

In the illustrated embodiment, acknowledgment feedback for the aggregated component carriers is transmitted over the uplink channel using a component-carrier-to-ACK/NACK mapping. For example, Rel-8 TDD HARQ feedback methods (called channel selection) can be modified to support new requirements for LTE-A such as carrier aggregation up to 4 carriers with DL SIMO transmission by changing the subframe-to-ACK/NACK mapping to component-carrier-to-ACK/NACK mapping. Table 2 illustrates an exemplary embodiment of a mapping of the control channel information to uplink control channel resources. In the illustrated embodiment, four carriers are aggregated on the downlink and the resources of a single uplink component carrier are used to support a single physical uplink control channel (PUCCH) that conveys the acknowledgment feedback over the air interface. However, persons of ordinary skill in the art having benefit of the present disclosure should appreciate that this particular mapping for a 4:1 relation between the downlink component carriers and the uplink component carriers is intended to be illustrative. In alternative embodiments, other mappings may be used for this or other numbers of uplink and/or downlink component carriers.

In the illustrated embodiment, values of the acknowledgement feedback for the different component carriers are mapped to uplink channel resources and values of the symbols conveyed in the resources. For example, for the 4:1 relation, four uplink channel resource blocks (n_{PUCCH,i}¹) may be used to support the PUCCH and each resource block may be used to convey a quadrature phase shift key (QPSK) symbol constellation, which may be represented using two bits (b0, b1). Each combination of an uplink channel resource block and a value of the QPSK symbol is mapped to a particular combination of feedback values (ACK, NACK, DTX) for the four component carriers. The base station 105 may therefore determine the feedback indications for each of the component carriers by decoding the single uplink control channel. The base station 105 can use the information to determine whether information transmitted on each component carrier was successfully received and/or whether any of the information transmitted over any of the component carriers should be retransmitted.

TABLE 2
Transmission of Format 1b ACK/NACK channel selection for A = 4

| HARQ- | HARQ- | HARQ- | HARQ- | | |
|---|---|---|---|---|---|
| ACK(0) | ACK(1) | ACK(2) | ACK(3) | n_{PUCCH, i}^{(1, p)} | b(0)b(1) |
| ACK | ACK | ACK | ACK | n_{PUCCH, 1}⁽¹⁾ | 1, 1 |
| ACK | NACK/DTX | ACK | ACK | n_{PUCCH, 2}⁽¹⁾ | 0, 1 |
| NACK/DTX | ACK | ACK | ACK | n_{PUCCH, 1}⁽¹⁾ | 0, 1 |
| NACK/DTX | NACK/DTX | ACK | ACK | n_{PUCCH, 3}⁽¹⁾ | 1, 1 |
| ACK | ACK | ACK | NACK/DTX | n_{PUCCH, 1}⁽¹⁾ | 1, 0 |
| ACK | NACK/DTX | ACK | NACK/DTX | n_{PUCCH, 2}⁽¹⁾ | 0, 0 |
| NACK/DTX | ACK | ACK | NACK/DTX | n_{PUCCH, 1}⁽¹⁾ | 0, 0 |
| NACK/DTX | NACK/DTX | ACK | NACK/DTX | n_{PUCCH, 3}⁽¹⁾ | 1, 0 |
| ACK | ACK | NACK/DTX | ACK | n_{PUCCH, 2}⁽¹⁾ | 1, 1 |
| ACK | NACK/DTX | NACK/DTX | ACK | n_{PUCCH, 2}⁽¹⁾ | 1, 0 |
| NACK/DTX | ACK | NACK/DTX | ACK | n_{PUCCH, 3}⁽¹⁾ | 0, 1 |
| NACK/DTX | NACK/DTX | NACK/DTX | ACK | n_{PUCCH, 3}⁽¹⁾ | 0, 0 |
| ACK | ACK | NACK/DTX | NACK/DTX | n_{PUCCH, 0}⁽¹⁾ | 1, 1 |
| ACK | NACK/DTX | NACK/DTX | NACK/DTX | n_{PUCCH, 0}⁽¹⁾ | 1, 0 |
| NACK/DTX | ACK | NACK/DTX | NACK/DTX | n_{PUCCH, 0}⁽¹⁾ | 0, 1 |
| NACK/DTX | NACK | NACK/DTX | NACK/DTX | n_{PUCCH, 0}⁽¹⁾ | 0, 0 |
| NACK | NACK/DTX | NACK/DTX | NACK/DTX | n_{PUCCH, 0}⁽¹⁾ | 0, 0 |

| | | | | |
|---|---|---|---|---|
| DTX | DTX | NACK/DTX | NACK/DTX | No Transmission |

Embodiments of the mapping depicted in Table 2 can be used to generate acknowledgment feedback for user equipment that do not support downlink MIMO so that the feedback (ACK. NACK, DTX) for the four carriers can be mapped to the uplink resources and QPSK modulation symbols. Downlink MIMO may allow the base station 105 to transmit two codewords on each component carrier, which may require HARQ feedback for two codewords per component carrier. User equipment that support downlink MIMO may therefore use embodiments of the mapping depicted in Table 2 to generate acknowledgment feedback for up to two component carriers. Additional feedback can be provided by extending embodiments of the channel selection technique described herein to support multiple uplink control channels in the uplink component carrier and/or using spatial bundling.

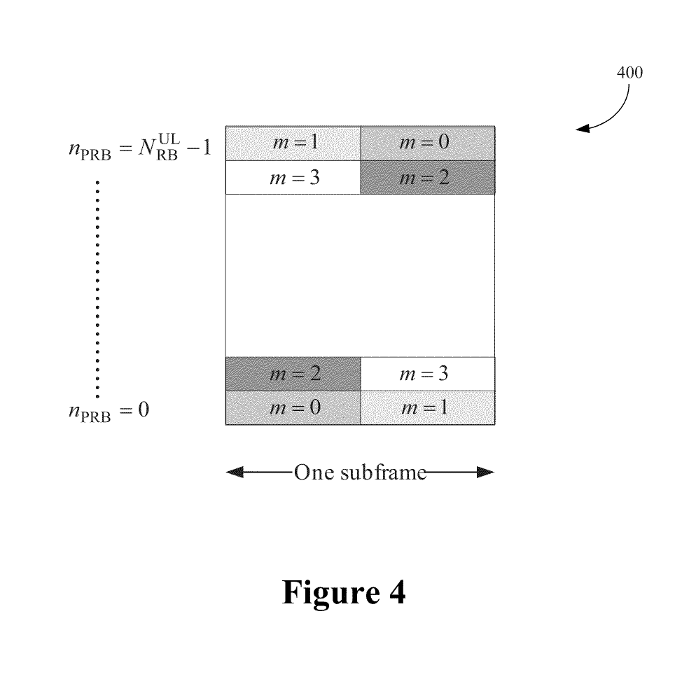

FIG. 4 conceptually illustrates one exemplary embodiment of a resource allocation 400 for providing acknowledgment feedback over multiple uplink control channels. The illustrated embodiment depicts one possible allocation of physical resource blocks in one subframe to as many as four different channels. Each channel is indicated by a value of the index m. The illustrated distribution is selected so that pairs of the channels can be allocated to physical resource blocks on adjacent frequencies. For example, the channels m=0 and m=2 are allocated to adjacent physical resource blocks in both the slots of the subframe. The illustrated distribution also allocates each channel to a physical resource block at a different frequency in the different slots and switches the pairs of channels so that one channel is at a higher frequency in one slot and the other channel is at a higher frequency in the other slot. For example, the channels m=0 and m=2 are allocated to physical resource blocks n_{PRB}=0 and n_{PRB}=1, respectively, in the first slot of the subframe and physical resource blocks n_{PRB}=N_{RB}^{UL}−1 and n_{PRB}=N_{RB}^{UL}−2, respectively, in the second slot of the subframe. Allocations such as the one depicted in FIG. 4 may help to increase frequency and/or time diversity gain for the uplink channels.

Multiple physical uplink control channels can increase the number of feedback bits that can be used to provide acknowledgments for aggregated downlink component carriers. In one embodiment, information representing up to 8 feedback bits can be transmitted using four uplink resources for each of the uplink control channels and QPSK modulation of the symbols transmitted in the uplink resources. The enhanced feedback can be used to support more than four aggregated component carriers, such as the five downlink component carriers supported by LTE-A, when a single codeword is transmitted on each downlink component carrier. When MIMO is used to increase the number of codewords transmitted on each downlink carrier, the additional feedback bits can be used to support HARQ feedback for each codeword. For example, the 8 acknowledgment bits can be used to acknowledge reception of two codewords transmitted on each of four downlink component carriers.

Intermodulation distortion (IMD) may affect PUCCH transmissions when multiple PUCCHs are multiplexed onto concurrent transmissions in non-adjacent resource blocks. However, no such issues are foreseen with multiple concurrent PUCCH transmissions in resource blocks that are adjacent in frequency. Therefore IMD should not prevent the use of multiple concurrent PUCCH transmissions. In one embodiment, specification can be made that when multiple simultaneous PUCCH transmissions occur, they shall occupy resource blocks that are adjacent in frequency. The network may then specify a configuration to ensure that suitable adjacent PUCCH resource blocks were assigned. Alternatively, adjacent PRB allocation could be explicitly mandated by specification in the standard. In some cases, there may be potential channel estimation loss due to power split among DM RSs mapped to two PRBs. However it is foreseen that the user equipment supporting aggregation of 5 CCs would have good geometry and may not be applicable to power-limited user equipment. For user equipment capable of supporting aggregation of 5 carriers, channel estimation would not likely become a bottleneck in PUCCH ACK/NACK channel performance.

Referring back to FIG. 1, the base station 105 may use the multiple antennas 120 to support downlink MIMO. The base station 105 may therefore be able to transmit multiple codewords on each downlink component carrier. The uplink control channel on the uplink component carrier may therefore be configured to provide acknowledgment information to indicate whether the codewords on each of the aggregated component carriers have been successfully received. In the illustrated embodiment, the base station 105 may aggregate more than four downlink component carriers and transmit two codewords on each aggregated downlink component carrier. Thus, in some cases, the mobile unit 110 may provide feedback information that represents more than 8 acknowledgment bits. Spatial bundling may be used provide additional feedback information for aggregated downlink component carriers. In the illustrated embodiment, spatial bundling may be used in conjunction with multiple uplink control channel allocation to increase the amount of feedback information. For example, spatial bundling of codewords transmitted onto downlink component carriers may allow acknowledgement feedback to be provided for 9 or more codewords. However, in alternative embodiments, spatial bundling may be used instead of multiple uplink control channel allocation to increase the amount of feedback information.

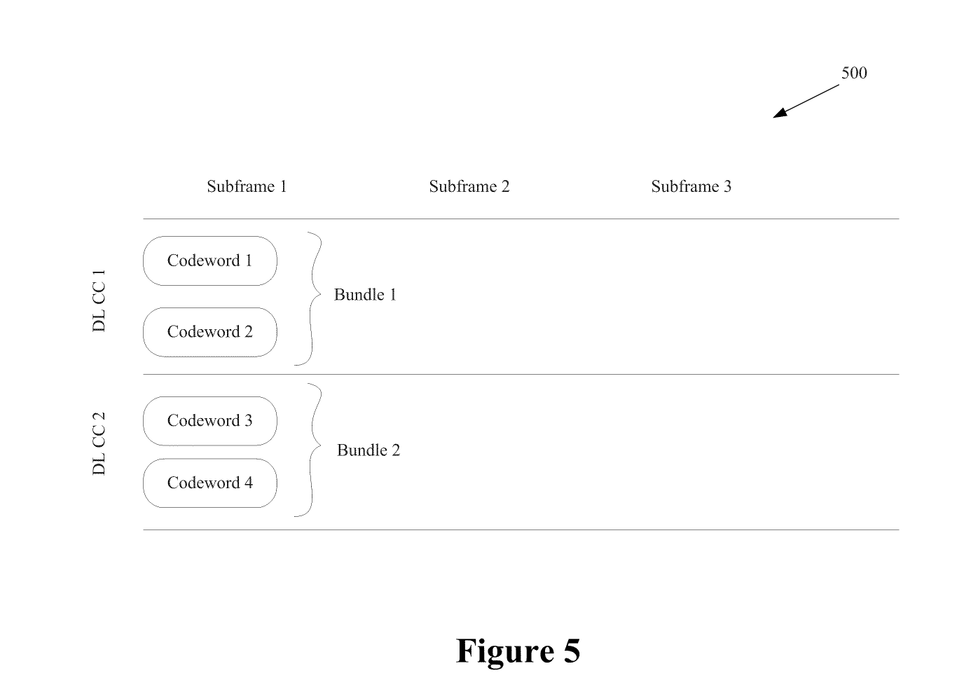

FIG. 5 conceptually illustrates one exemplary embodiment 500 of spatial bundling of codewords transmitted on component carriers. In the illustrated embodiment, two downlink component carriers (DL CC 1, DL CC 2) are used to transmit two codewords per carrier in each subframe. For example, the codewords Codeword 1/Codeword 2 may be transmitted on the first downlink component carrier DL CC1 and the codewords Codeword 3/Codeword 4 may be transmitted on the second downlink component carrier DL CC2. The codewords on each of the downlink component carriers may then be bundled and acknowledgement feedback can be provided for each of the bundles. For example, spatial bundling allows a single feedback bit to be used for acknowledgment of the two codewords in each of the bundles. The number of feedback bits required to acknowledge the four codewords transmitted over the downlink component carriers in each subframe may therefore be reduced from 4 bits to 2 bits.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
determining, at user equipment, a plurality of acknowledgment bits for a plurality of downlink component carriers that are aggregated to the user equipment, each acknowledgment bit indicating whether a corresponding downlink component carrier was successfully received; and
transmitting symbol constellations representative of the acknowledgment bits in a plurality of resources of at least one uplink control channel of the uplink component carrier.

2. The method of claim 1, comprising mapping the acknowledgment bits to the symbol constellations and the plurality of resources of said at least one uplink control channel.

3. The method of claim 2, wherein mapping the acknowledgment bits to the symbol constellations and the plurality of resources comprises mapping acknowledgment bits so that each combination of a value of the symbol constellation and one of the plurality of resources indicates a different combination of acknowledgment bits.

4. The method of claim 3, wherein four downlink component carriers are aggregated to the user equipment and wherein mapping the acknowledgment bits to the symbol constellation and the plurality of resources comprises mapping the acknowledgment bits to values of quadrature phase shift keying (QPSK) symbol constellations and four predetermined resource blocks of said at least one uplink control channel.

5. The method of claim 3, wherein said at least one uplink control channel comprises a pair of uplink control channels, and wherein mapping the acknowledgment bits to the symbol constellations and the plurality of resources comprises mapping the acknowledgment bits so that each combination of a value of the symbol constellation and one of the plurality of resources in the pair of uplink control channels indicates a different combination of acknowledgment bits.

6. The method of claim 5, wherein the pair of uplink control channels are allocated to frequency-adjacent resource blocks, and wherein a different pair of frequency-adjacent resource blocks are allocated to the pair of uplink control channels in the slots of each subframe of the uplink control channels.

7. The method of claim 5, wherein each of the plurality of downlink component carriers transmits two codewords, and wherein determining the plurality of acknowledgment bits comprises determining acknowledgment bits for each code word transmitted on each of the plurality of downlink component carriers.

8. The method of claim 7, wherein more than four downlink component carriers are aggregated to the user equipment and wherein determining the plurality of acknowledgment bits comprises determining at least one acknowledgment bit for at least one spatially bundled pair of downlink component carriers.

9. The method of claim 8, wherein mapping the acknowledgment bits to the symbol constellation and the plurality of resources comprises mapping the acknowledgment bits comprising said at least one acknowledgment bit for said at least one spatially bundled pair of downlink component carriers to values of QPSK symbol constellations and four predetermined resource blocks of said at least one uplink control channel.

10. The method of claim 1, comprising receiving information indicating which of the plurality of downlink component carriers include downlink control channel transmissions, and detecting at least one discontinuous transmission (DTX) based on the information indicating which of the plurality of downlink component carriers include downlink control channel transmissions.

11. A method, comprising:
transmitting, from a base station to at least one user equipment, a plurality of downlink component carriers that are aggregated to said at least one user equipment;
receiving a plurality of symbol constellations representative of a plurality of acknowledgment bits for the plurality of downlink component carriers in a plurality of resources of at least one uplink control channel of an uplink component carrier, each acknowledgment bit indicating whether a corresponding downlink component carrier was successfully received.

12. The method of claim 11, comprising determining values of the plurality of acknowledgment bits using a predetermined mapping of the acknowledgment bits to the symbol constellations and the plurality of resources.

13. The method of claim 12, wherein determining the values of the plurality of acknowledgment bits using the predetermined mapping comprises determining the values of the plurality of acknowledgment bits using a predetermined mapping that indicates that each combination of a value of the symbol constellation and one of the plurality of resources indicates a different combination of acknowledgment bits.

14. The method of claim 13, comprising aggregating four downlink component carriers to said at least one user equipment and wherein the predetermined mapping indicates the predetermined mapping of values of the acknowledgment bits to values of quadrature phase shift keying (QPSK) symbol constellations and four predetermined resource blocks of said at least one uplink control channel.

15. The method of claim 13, receiving the symbol constellations in the plurality of resources of said at least one uplink control channel comprises receiving the symbol constellations in a plurality of resources of a pair of uplink control channels, and wherein the predetermined mapping of the acknowledgment bits to the symbol constellations and the plurality of resources comprises a predetermined mapping of the acknowledgment bits to values of the symbol constellation and one of the plurality of resources in the pair of uplink control channels.

16. The method of claim 15, wherein receiving the symbol constellations over the pair of uplink control channels comprises receiving the symbol constellations over a pair of uplink control channels allocated to frequency-adjacent resource blocks, and wherein a different pair of frequency-adjacent resource blocks are allocated to the pair of uplink control channels in the slots of each subframe of the uplink control channels.

17. The method of claim 15, comprising transmitting two codewords over each of the plurality of downlink component carriers, and wherein receiving the plurality of acknowledgment bits comprises receiving acknowledgment bits for each code word transmitted on each of the plurality of downlink component carriers.

18. The method of claim 17, comprising aggregating more than four downlink component carriers to the user equipment and wherein receiving the plurality of acknowledgment bits comprises receiving at least one acknowledgment bit for at least one spatially bundled pair of downlink component carriers.

19. The method of claim 18, wherein receiving the symbol constellations representative of the plurality of acknowledgment bits comprises receiving symbol constellations representative of acknowledgment bits comprising said at least one acknowledgment bit for said at least one spatially bundled pair of downlink component carriers, and wherein the values of each acknowledgment bit are mapped to values of QPSK symbol constellations and four predetermined resource blocks of said at least one uplink control channel.

20. The method of claim 11, comprising transmitting information indicating which of the plurality of downlink component carriers include downlink control channel transmissions.

21. The method of claim 11, determining values of the acknowledgment bits based on the received symbol constellations in the plurality of resources.

22. The method of claim 21, comprising determining whether to retransmit any of the downlink component carriers based on the values of the acknowledgment bits.

23. A method, comprising:
mapping, at user equipment, acknowledgment bits to symbol constellations for transmission in a plurality of resources of an uplink control channel, wherein the acknowledgment bits indicate whether codewords transmitted over aggregated downlink component carriers were successfully received at the user equipment.

24. The method of claim 23, wherein mapping the acknowledgment bits to the symbol constellations and the plurality of resources comprises mapping acknowledgment bits so that each combination of a value of the symbol constellation and one of the plurality of resources indicates a different combination of acknowledgment bits.
